(19) United States
(12) Patent Application Publication
(10) Pub. No.: US 2021/0004883 A1
(43) Pub. Date: Jan. 7, 2021

(54) Compliance And Acknowledgement Plan for Vehicle Dealers And Buyers

(71) Applicants: Ali Kamarei, Los Altos, CA (US); Ali Rakhshanifar, Gilroy, CA (US)

(72) Inventors: Ali Kamarei, Los Altos, CA (US); Ali Rakhshanifar, Gilroy, CA (US)

(21) Appl. No.: 16/460,425

(22) Filed: Jul. 2, 2019

(51) Int. Cl. G06Q 30/06; G06Q 30/00

(52) U.S. Cl. CPC G06Q 30/0607; G06Q 30/018

(57) ABSTRACT

A computer-implemented method and system to aid vehicle dealers and vehicle buyers in making and receiving vehicle disclosures, using a network application, comprising; a) receipt by an electronic device a vehicle type input from a vehicle dealer, (b) generating and presenting to the vehicle dealer, one or more compliance plan screens, the compliance plan screens constituting a series of predetermined prompts regarding a vehicle's condition and prior use, c) requiring the vehicle dealer to provide dealer input to certain predetermined prompts, d) the input by the vehicle dealer to the predetermined prompts triggering formation of one or more corresponding responsive disclosure screens, e) presentation of one or more responsive disclosure screens to a vehicle buyer disclosing the vehicle's condition and prior use to the vehicle buyer, the acknowledgement by the vehicle buyer generating at least one acknowledgement code, and f) transmission from the one or more electronic devices to a server, at least one acknowledgement code of the vehicle buyer, indicating disclosures by the vehicle dealer and acknowledgements by the vehicle buyer.

### BACKGROUND

The vehicle sales industry is huge. An estimated 17.5 million new vehicles are sold each year. It is estimated that approximately twice that much, or approximately 34 million used vehicles are sold every year. Americans owe approximately $1.1 Trillion dollars on their vehicles. For many, the purchase of a vehicle is the most expensive purchase they make as well a vehicle is purchased on average once every 4 years. It is not without coincidence that the auto sales industry remains one of the most regulated industries. Significant Federal and State Laws have been implemented to protect consumers from unknowledgeable as well as unscrupulous dealers. Despite the existence of these various laws, improper disclosures result in thousands of lawsuits per year, costing buyers, banks and finance companies, bond companies, and even dealers themselves, billions of dollars.

Many of the Federal and State regulations require that the dealer disclose a vehicle's prior condition and prior use prior to the sale of the vehicle, and sometimes at the time a vehicle is offered for sale as it sits at the dealership. Furthermore, there are many advertisement regulations which are not necessarily limited to advertisements in mass media, but even extend to oral statements made to the buyers at the time of sale.

The sales process is complex, involving negotiations over terms. Sometimes the buyers are in a rush, and sometimes the dealership is busy over the weekend or holiday. Unfortunately, through inadvertence, hyperbole, and sometimes intentionally, a vehicles prior condition and prior use as it is known to the dealer, is either not disclosed at all, not disclosed properly, or not disclosed prior to purchase. In addition, paper disclosures have been, and continue to be, subject to being doctored, manipulated, and fraud. Some dealers have been found to obtain signatures from buyers on blank forms only to later fill in the blanks with disclosures, and buyers have been found to dispute their signatures and the disclosures after proper disclosures had been made to them. Furthermore, oral statements can be made to the buyer which could be misunderstood.

Additionally, a vehicle's prior use or condition is usually not available to a dealer from a single source of information. For example, there may be defects that are visible to a dealer, but which is not reflected in a third-party vehicle information provider. Information regarding SMOG, prior accidents, title discrepancy, and the like are generally not available from a single source. Similarly, there are many times that a dealer does not know the true condition of a vehicle, because they are not visible at the time of sale or in a pre-sale safety inspection.

Finally, certain states require that when negotiations are conducted in certain protected languages, that the contracts entered into also be translated to the language used during the negotiations. For example, in California, Spanish, Chinese, Korean, Tagalog, and Vietnamese are protected languages. The Federal Government requires that the “Buyers Guide” for used vehicles be displayed in both English and Spanish, when a dealer sells a certain number of cars to Spanish speaking customers.

Accordingly, there remains a need for a method and device that would generate a compliance and acknowledgement plan to coax and prompt a dealer to make the proper disclosure to the customer and have the acknowledgement of the customer, to ensure that the compliance plan is adhered to and the necessary disclosures are made to the customer. There is also a need for disclosure screens that are generated based upon disclosures made by the dealer, so as to prevent manipulation and/or fraud by the dealer and the buyer.

There is also a need for a standardized method and system that prompts a dealer to properly provide disclosures to the buyer depending on the type of vehicle, and which is electronically date and/or time stamped so as to prevent future manipulation.

Furthermore, there is a need for an integrated system for disclosure of the current condition of a used vehicle that is visually observable and its prior use and condition history to a perspective buyer.

### SUMMARY

In an embodiment of the present invention, a computer-implemented method using a network application, comprises of receipt by one or more devices a vehicle type input from a vehicle dealer, in response to the vehicle type input, the one or more devices generating and presenting to the vehicle dealer, one or more compliance plan screens, the compliance plan screens constituting a series of predetermined prompts regarding a vehicle's condition and prior use, requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering formation of one or more corresponding responsive disclosure screens, presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code, and transmission from the one or more devices to a server, of the predetermined prompts responded to by the dealer, answers thereto by the buyer, and the at least one acknowledgement code of the vehicle buyer, indicating proper disclosures by the vehicle dealer and proper acknowledgements by the vehicle buyer.

In a preferred embodiment, the device generates a date stamp and time stamp, recording the date and time the vehicle buyer acknowledged the disclosure screens.

In a preferred embodiment, the type of vehicle consists of the group “new” or “used” vehicle.

In yet another preferred embodiment, the dealer input to the predetermined prompts comprises transmission of vehicle photos from the one or more devices to the server.

In a preferred embodiment, the vehicle identification number (VIN) is transmitted from the one or more devices to the server. Preferably, the vehicle identification number (VIN) is used for obtaining the make, model, and year of the vehicle.

In a preferred embodiment, an activation code is transmitted by the computer-implemented method to a third-party vehicle history provider to access third-party records unique to a vehicle identified by the vehicle identification number (VIN).

In a more preferred embodiment, further comprises receiving input data from the third-party vehicle history provider for presentation of disclosure screens to the buyer. In this embodiment, it is understood that vehicle disclosure screens are generated by the computer-implemented method for display to the buyer for their acknowledgement. Also in this embodiment, the input data from the third-party is used to evaluate the vehicle dealer's compliance with the compliance plan. Also in this embodiment, the dealer has the option to augment the disclosure screens with information previously unknown to the vehicle dealer.

In an embodiment of the present invention, the vehicle prior use comprises of the group; prior use as a taxi, rideshare vehicle, publicly owned vehicle, previously leased vehicle, previously fleet vehicle, previously dealer vehicle, and previously dealer loaner vehicle.

In an embodiment of the present invention, the vehicle condition history comprises of the group; previously deployed airbag, lifted vehicle, previously painted vehicle, known frame damage vehicle, open recall announced by manufacturer, correct odometer unknown, and previously out of state vehicle.

In a preferred embodiment, the disclosure screens are electronically hand signed by the vehicle buyer.

In a preferred embodiment, a pdf of the predetermined prompts responded to by the vehicle dealer, answers thereto by the buyer, and the acknowledgement codes and physical signatures of the vehicle buyer in response to the disclosure screens is generated and emailed to the vehicle buyer.

In a preferred embodiment, the buyer selects the language they wish to see the disclosure screens in from a list of languages provided by the computer-implemented method and system.

In an embodiment, the buyer is asked whether they have taken a test drive of the identified vehicle. In this embodiment, the buyer is asked how long they test drove the vehicle.

The invention discloses a system, comprising: a data storage device storing instructions for causing computer servers or mobile devices to generate a compliance plan for vehicle dealers; and a processing device configured to execute disclosure screens for vehicle buyers in response to the compliance plan, to perform a method of:

a) receipt by one or more devices a vehicle type input from a vehicle dealer,

b) in response to the vehicle type input, the one or more devices generating and presenting to the vehicle dealer, one or more compliance plan screens, the compliance plan screens constituting a series of predetermined prompts regarding a vehicle's condition and prior use,

c) requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering formation of one or more corresponding responsive disclosure screens,

d) presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code,

e) transmission from the one or more devices to a server, of the predetermined prompts responded to by the dealer, answers thereto by the buyer, and the at least one acknowledgement code of the vehicle buyer, indicating disclosures by the vehicle dealer and acknowledgements by the vehicle buyer.

In this embodiment of the system, it further comprises the device generating a date stamp and time stamp, recording the date and time the vehicle buyer acknowledged the disclosure screens.

The invention discloses a non-transitory computer-readable medium storing instructions that, when executed by a processor, cause the processor to mobile devices to generate a compliance plan for vehicle dealers; and a processing device configured to execute disclosure screens for vehicle buyers in response to the compliance plan, to perform a method of:

a) receipt by one or more remote devices a vehicle type input from a vehicle dealer,

b) in response to the vehicle type input, the one or more remote devices generating and presenting to the vehicle dealer, one or more compliance plan screens, the compliance plan screens constituting a series of predetermined prompts regarding a vehicle's condition and prior use,

c) requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering formation of one or more corresponding responsive disclosure screens,

d) presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code,

e) transmission from the one or more remote devices to a server, of the predetermined prompts responded to by the dealer, answers thereto by the buyer, and the at least one acknowledgement code of the vehicle buyer, indicating disclosures by the vehicle dealer and acknowledgements by the vehicle buyer.

In this embodiment of the non-transitory computer-readable medium, it receives an activation code from the vehicle dealer to access third-party vehicle history providers unique to the vehicle identified by a VIN.

### BRIEF DESCRIPTION OF THE DRAWINGS

FIG. 1 shows an embodiment of the method and system of the invention.

FIG. 2 shows input of vehicle type.

FIG. 3 shows compliance plan screen with predetermined prompts and dealer input in free form.

FIG. 4 shows compliance plan screen with optional predetermined prompts and dealer input.

FIG. 5 shows a responsive disclosure screen with acknowledgement boxes, and electronic physical signature.

FIG. 6 shows compliance plan screen with predetermined prompts for dealer input as to a co-buyer.

FIG. 7 shows compliance plan screen with predetermined prompts for dealer input as to proof of insurance.

FIG. 8 shows a responsive disclosure screen with acknowledgement for language selection.

FIG. 9 shows an optional embodiment of the method and system of the invention for accessing third-party vehicle information providers.

FIG. 10 shows an optional embodiment of the method and system of the invention for generating a pdf and emailing the disclosure and acknowledgements to the vehicle buyer.

### DETAILED DESCRIPTION

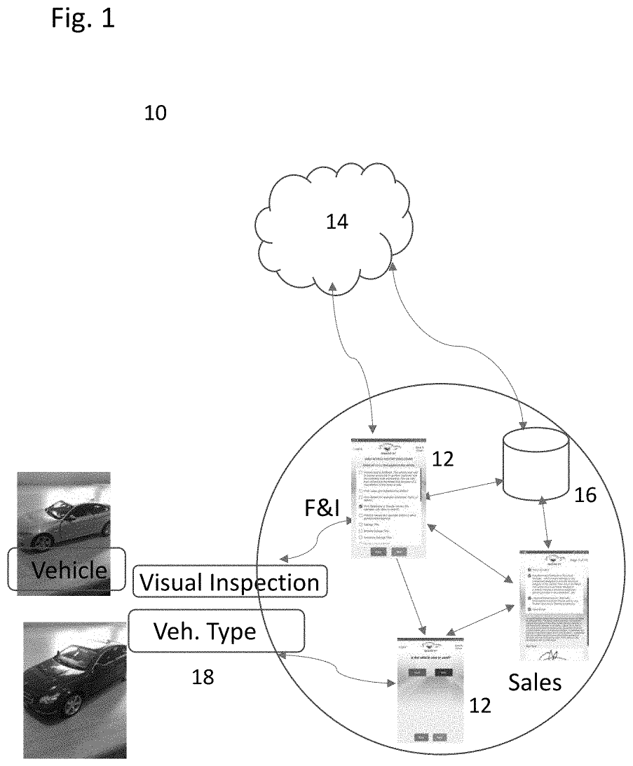

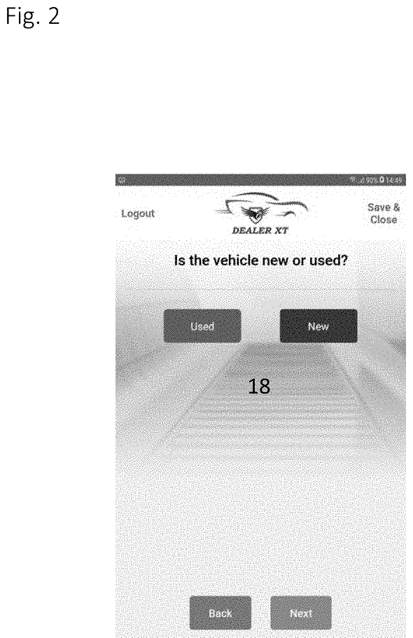

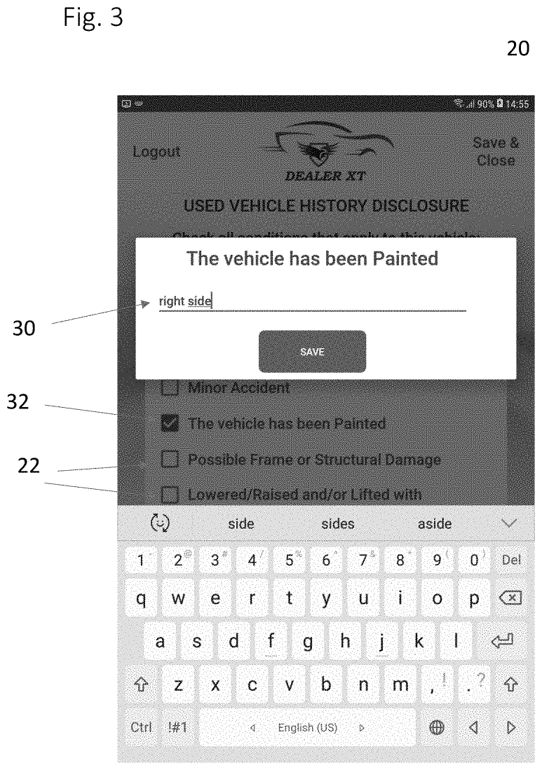

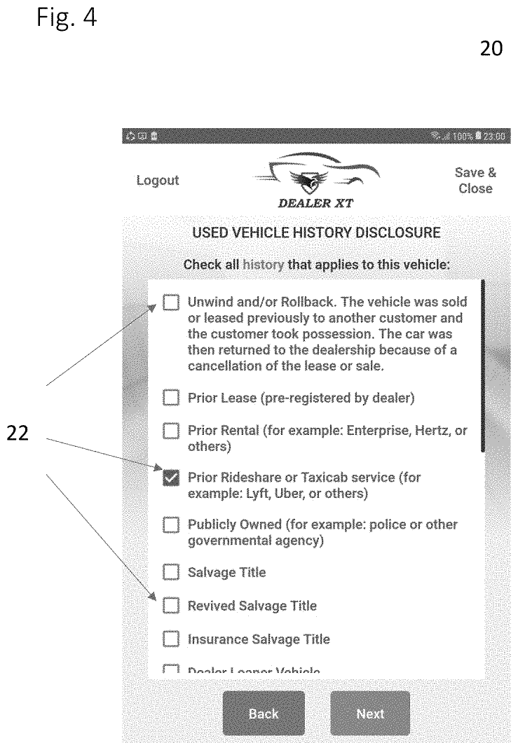

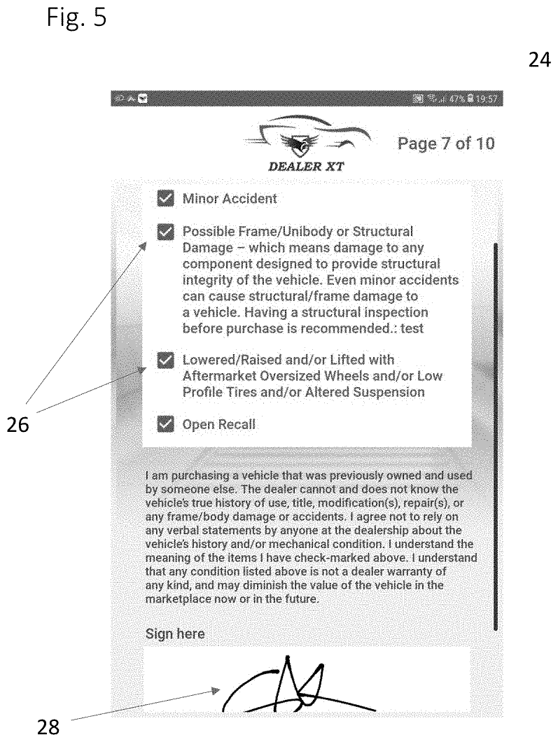

As shown in FIG. 1, the invention comprises of a computer-implemented method using a network application, 10 which comprises of receipt by one or more devices 12 a vehicle type 18 input from a vehicle dealer. The one or more devices are optionally at a location separate from a remote cloud server 14, or connected via local networks to local server 16. The local server 16 and one or more devices 12 are preferably located at a vehicle dealership. The devices are optionally located at both the sales department and the finance and insurance department (F&I). To initiate the method of the invention, as shown in FIGS. 1 and 2, a vehicle type 18 is entered by the dealer. The vehicle type 18 consists of the group New and Used. In response to the vehicle type 18 input, the one or more devices 12, which each host computer language, generate and present to the vehicle dealer, one or more compliance plan screens 20 in a predetermined sequence. The information on all of the devices 12 are optionally updated and made current as information is entered into one device 12. In an optional alternative embodiment, the information is not shared between the one or more devices 12 and information regarding a compliance plan is separately transmitted to the remote cloud server 14 or optionally local server 16. As shown in FIGS. 3 and 4, the compliance plan screens 20 constitute a series of predetermined prompts 22 regarding a vehicle's condition and prior use. The compliance plan screens 20 require the vehicle dealer to provide dealer input 32 to the predetermined prompts 22. Optionally, some predetermined prompts are mandatory and some not. Optionally the vehicle dealer is allowed to proceed forward with additional dealer input 32 only if mandatory predetermined prompts 22 are responded to by the vehicle dealer. It is understood that the dealer may optionally input information in free form response 30. The input by the vehicle dealer to the compliance plan predetermined prompts 22 triggers the one or more devices 12 to generate one or more corresponding responsive disclosure screens 24. As shown in FIG. 5, one or more responsive disclosure screens 24 are presented to a vehicle buyer disclosing the vehicle's condition and prior use to the vehicle buyer. The vehicle buyer is allowed to proceed forward with the responsive disclosure screens 24, if the disclosures are acknowledged 26 through an act of acknowledgement such as clicking in an empty box, by the vehicle buyer. The acknowledgement by the vehicle buyer generates at least one acknowledgement code 36. The predetermined prompts 22 responded to by the dealer, acknowledgements 26 thereto by the buyer, and the at least one acknowledgement code 36 of the vehicle buyer is transmitted from the one or more devices 12 to optionally the local server 16 or remote cloud server 14. Optionally, an electronic signature 28 of the buyer is obtained on the one or more devices.

In an optionally preferred embodiment, the one or more devices generate a date stamp and/or time stamp, recording the date and/or time the vehicle buyer acknowledged the disclosure screens.

In yet another optionally preferred embodiment, the dealer input to the predetermined prompts comprises transmission of vehicle photos from the one or more devices to the server. In this embodiment, a date and/or time stamp is generated to evidence the date and/or time the photo of the vehicle was taken.

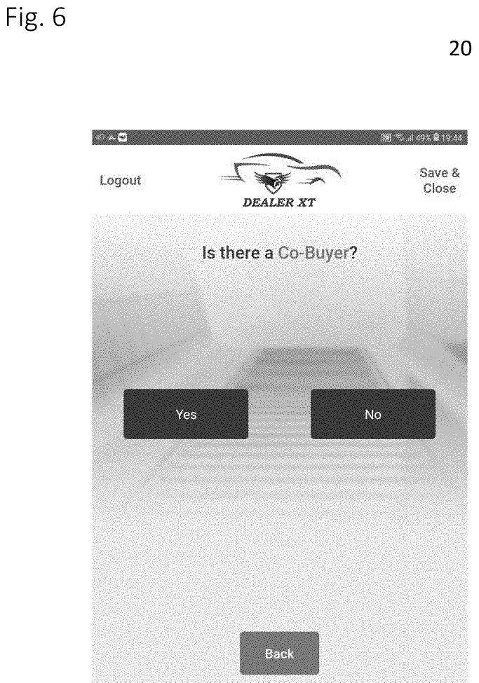

In another optionally preferred embodiment, as shown in FIG. 6, the device generates a prompt 20 for the vehicle dealer as to whether there is a co-buyer, so responsive disclosure screens can be generated for a co-buyer of the vehicle.

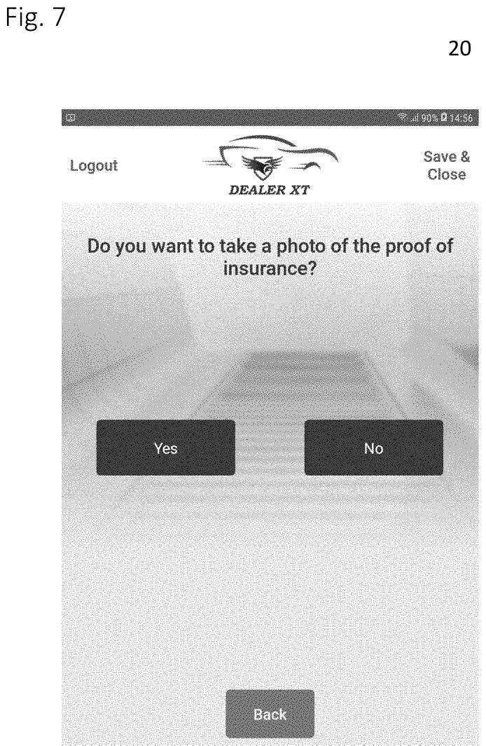

In another optional embodiment, as shown in FIG. 7, the device generates a prompt 20 for the vehicle dealer as to whether the proof of insurance needs to be collected from the vehicle buyer.

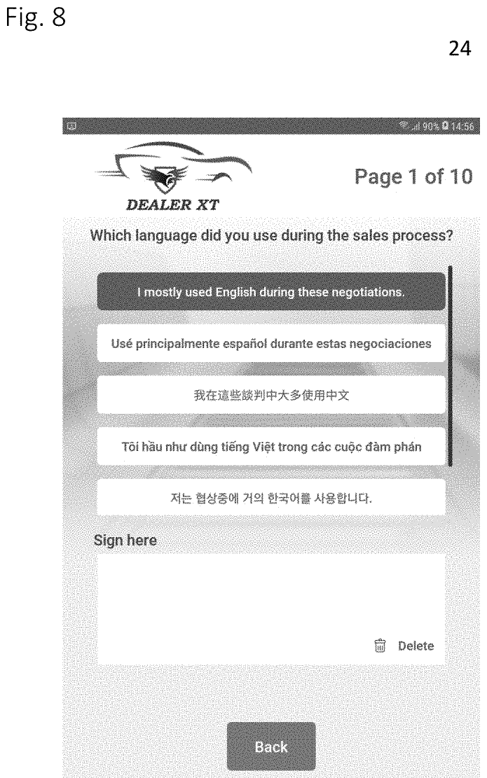

In another optional embodiment, as shown in FIG. 8, the device generates a responsive disclosure screen 24 for the vehicle dealer asking their language preference for receiving disclosures. When the buyer selects a language, the disclosure made by the vehicle dealer will be displayed to the vehicle buyer in the selected language.

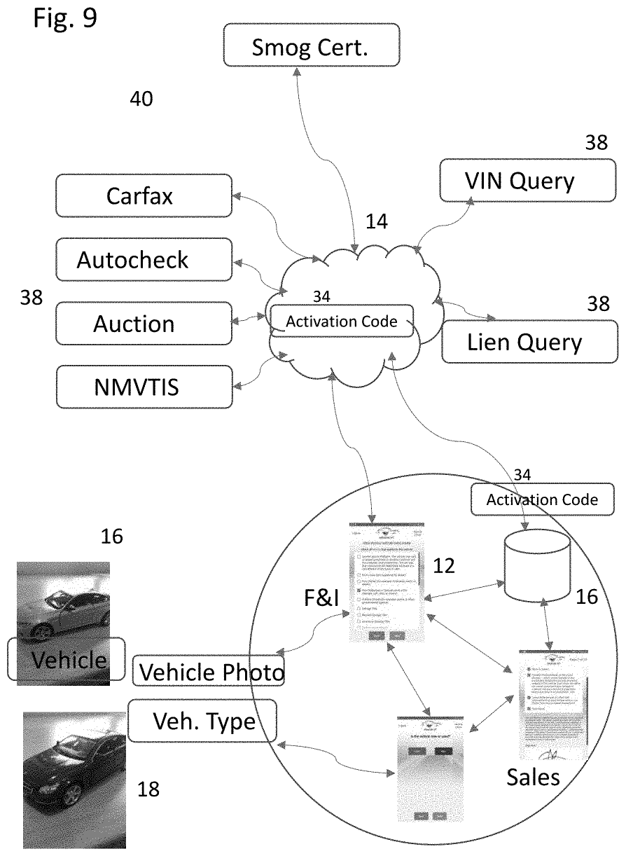

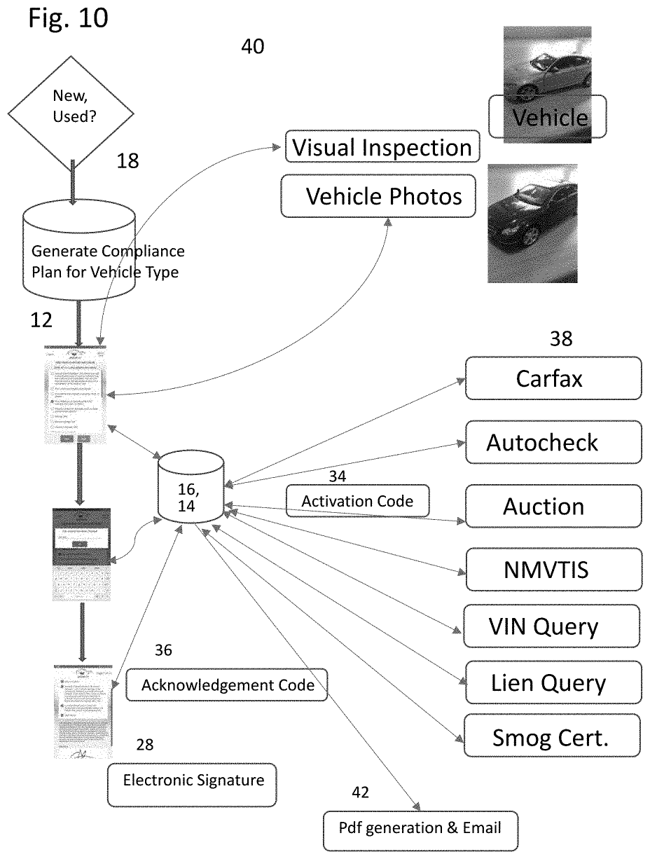

As is shown in FIGS. 9 and 10, in an optionally preferred embodiment 40, an activation code 34 is transmitted by the computer-implemented method and system 10 to a third-party vehicle history provider 38 to access third-party records unique to a vehicle identified by a vehicle identification number (VIN). The vehicle identification number (VIN) is transmitted from the one or more devices to the local server 16 or optionally remote cloud server 14. Preferably, the vehicle identification number (VIN) is used for obtaining the make, model, and year of the vehicle from a third-party information provider 38.

In an optional embodiment, the computer-implemented method further comprises receiving input data from the third-party vehicle history provider for presentation of predetermined prompts 22 in compliance plan screens 20 to the vehicle dealer. Also in this embodiment, input data from the third-party is used to evaluate the vehicle dealer's compliance with the compliance plan. For example, if after a visual inspection of the vehicle, the dealer has not noticed that the vehicle has been painted, but the third-party input indicates that the vehicle has been in an accident, and alert is generated to the vehicle dealer to appraise the dealer of the discrepancy in disclosure and then the vehicle dealer can change its previous disclosure. In this embodiment, it is understood that vehicle disclosure screens 24 are generated as a result of input by third party 38 by the computer-implemented method and system 10 for display to the buyer for the buyer's acknowledgement. In this embodiment, the dealer has the option to augment the disclosure screens with information known to the vehicle dealer but not known to the third-party information providers.

In an optional embodiment of the present invention, the vehicle prior use input comprises of the group; prior use as a taxi, rideshare vehicle, publicly owned vehicle, previously leased vehicle, previously fleet vehicle, previously dealer vehicle, and previously dealer loaner vehicle.

In an optional embodiment of the present invention, the vehicle condition history input comprises of the group; previously deployed airbag, lifted vehicle, previously painted vehicle, known frame damage vehicle, open recall announced by manufacturer, correct odometer unknown, and previously out of state vehicle.

In an optionally preferred embodiment, the disclosure screens are electronically hand signed 28 by the vehicle buyer.

In an optionally preferred embodiment, a pdf of the predetermined prompts responded to by the vehicle dealer, answers thereto by the buyer, and the acknowledgement codes and physical signatures of the vehicle buyer in response to the disclosure screens is generated and emailed to the vehicle buyer 42. It is understood that as one of the prompts to the vehicle buyer, an email address of the buyer is obtained.

In an optional embodiment, a responsive disclosure screen asks the buyer whether they have taken a test drive of the vehicle. In this embodiment, the buyer is optionally asked how long they test drove the vehicle.

The invention discloses a system, comprising: a data storage device storing instructions for causing computer servers or mobile devices to generate a compliance plan for vehicle dealers; and a processing device configured to execute disclosure screens for vehicle buyers in response to the compliance plan, to perform a method of:

a) receipt by one or more devices a vehicle type input from a vehicle dealer,

b) in response to the vehicle type input, the one or more devices generating and presenting to the vehicle dealer, one or more compliance plan screens, the compliance plan screens constituting a series of predetermined prompts regarding a vehicle's condition and prior use,

c) requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering formation of one or more corresponding responsive disclosure screens,

d) presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code,

e) transmission from the one or more devices to a server, of the predetermined prompts responded to by the dealer, answers thereto by the buyer, and the at least one acknowledgement code of the vehicle buyer, indicating disclosures by the vehicle dealer and acknowledgements by the vehicle buyer.

In this embodiment of the system, it further comprises the device generating a date stamp and time stamp, recording the date and time the vehicle buyer acknowledged the disclosure screens.

The invention discloses a non-transitory computer-readable medium storing instructions that, when executed by a processor, cause the processor to mobile devices to generate a compliance plan for vehicle dealers; and a processing device configured to execute disclosure screens for vehicle buyers in response to the compliance plan, to perform a method of:

a) receipt by one or more remote devices a vehicle type input from a vehicle dealer,

b) in response to the vehicle type input, the one or more remote devices generating and presenting to the vehicle dealer, one or more compliance plan screens, the compliance plan screens constituting a series of predetermined prompts regarding a vehicle's condition and prior use,

c) requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering formation of one or more corresponding responsive disclosure screens,

d) presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code,

e) transmission from the one or more remote devices to a server, of the predetermined prompts responded to by the dealer, answers thereto by the buyer, and the at least one acknowledgement code of the vehicle buyer, indicating disclosures by the vehicle dealer and acknowledgements by the vehicle buyer.

In this embodiment of the non-transitory computer-readable medium, it receives an activation code from the vehicle dealer to access third-party vehicle history providers unique to the vehicle identified by a VIN.

The present invention has been described in relation to particular examples, which are intended in all respects to be illustrative rather than restrictive. Those skilled in the art will appreciate that other implementations of the invention will be apparent to those skilled in the art from consideration of the specification and practice of the invention disclosed herein. Various aspects and/or components of the described embodiments may be used alone or in any combination. It is intended that the specification and examples be considered as exemplary only, with a true scope and spirit of the invention being indicated by the following claims.

What is claimed is:

1. A computer-implemented method using a network application, comprising:
receipt by one or more devices a vehicle type input from a vehicle dealer,
in response to the vehicle type input, the one or more devices generating and presenting to the vehicle dealer, one or more compliance plan screens, the compliance plan screens constituting a series of predetermined prompts regarding a vehicle's condition and prior use,
requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering generation of one or more corresponding responsive disclosure screens,
presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code,
transmission from the one or more devices to a server, of the predetermined prompts responded to by the dealer, acknowledgements thereto by the buyer, and the at least one acknowledgement code of the vehicle buyer, indicating disclosures by the vehicle dealer and acknowledgements by the vehicle buyer.

2. The method of claim 1, further comprising the device generating a date stamp and time stamp, recording the date and time the vehicle buyer acknowledged the disclosure screens.

3. The method of claim 1, wherein the type of vehicle consists of the group “new” or “used” vehicle.

4. The method of claim 1, wherein the dealer input to the predetermined prompts comprises transmission of vehicle photos from the one or more devices to the server.

5. The method of claim 1 further comprising transmitting a vehicle identification number (VIN) from the one or more devices to the server.

6. The method of claim 1 further comprising transmitting a vehicle identification number (VIN) over a network for obtaining the make, model, and year of the vehicle.

7. The method of claim 1 further comprising an activation code being transmitted by the computer-implemented method to a third-party vehicle history provider to access third-party records unique to a vehicle identified by the vehicle identification number.

8. The method of claim 7 further comprising receiving input data from the third-party vehicle history provider for generating disclosure screens for the buyer.

9. The method of claim 8 wherein the input data from the third-party is used to evaluate the vehicle dealer's compliance with the compliance plan.

10. The method of claim 9, wherein the dealer augments the disclosure screens with information previously unknown to the vehicle dealer.

11. The method of claim 1 wherein the vehicle prior use comprises of the group; prior use as a taxi, rideshare vehicle, publicly owned vehicle, previously leased vehicle, previously fleet vehicle, previously dealer vehicle, and previously dealer loaner vehicle.

12. The method of claim 1 wherein the vehicle condition history comprises of the group; previously deployed airbag, lifted vehicle, previously painted vehicle, known frame damage vehicle, open recall announced by manufacturer, correct odometer unknown, and previously out of state vehicle.

13. The method of claim 1 wherein a pdf of the predetermined prompts responded to by the vehicle dealer, answers thereto by the buyer, and the acknowledgement codes and electronic signatures of the vehicle buyer in response to the disclosure screens is generated and emailed to the vehicle buyer.

14. The method of claim 1, wherein the disclosure screens are electronically hand signed by the vehicle buyer.

15. The method of claim 1, wherein the buyer selects the language they wish to see the disclosure screens in from a list of languages provided by the computer-implemented method.

16. The method of claim 1, wherein the buyer is asked whether they have taken a test drive of the identified vehicle.

17. The method of claim 16, wherein the buyer is asked how long they test drove the vehicle.

18. A system, comprising: a data storage device storing instructions for causing computer servers or mobile devices to generate a compliance plan for vehicle dealers; and a processing device configured to execute disclosure screens for vehicle buyers in response to the compliance plan, to perform a method of:
a) receipt by one or more devices a vehicle type input from a vehicle dealer,
b) in response to the vehicle type input, the one or more devices generating and presenting to the vehicle dealer, one or more compliance plan screens, the compliance plan screens constituting a series of predetermined prompts regarding a vehicle's condition and prior use,
c) requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering generation of one or more corresponding responsive disclosure screens,
d) presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code,
e) transmission from the one or more remote devices to a server, of the predetermined prompts responded to by the dealer, acknowledgements thereto by the buyer, and the at least one acknowledgement code of the vehicle buyer, indicating disclosures by the vehicle dealer and acknowledgements by the vehicle buyer.

19. The system of claim 18, further comprising the remote device generating a date stamp and time stamp, recording the date and time the vehicle buyer acknowledged the disclosure screens.

20. A non-transitory computer-readable medium storing instructions that, when executed by a processor, cause the processor to mobile devices to generate a compliance plan for vehicle dealers; and a processing device configured to execute disclosure screens for vehicle buyers in response to the compliance plan, to perform a method of:
a) receipt by one or more remote devices a vehicle type input from a vehicle dealer,
b) in response to the vehicle type input, the one or more remote devices generating and presenting to the vehicle dealer, one or more compliance plan screens, the compliance plan screens constituting a series of predetermined prompts regarding a vehicle's condition and prior use,
c) requiring the vehicle dealer to provide dealer input to the predetermined prompts, wherein the vehicle dealer is allowed to proceed forward with additional dealer input if mandatory predetermined prompts are answered by the vehicle dealer, the input by the vehicle dealer to the predetermined prompts triggering generation of one or more corresponding responsive disclosure screens,
d) presentation of one or more responsive disclosure screens to a vehicle buyer disclosing the vehicle's condition and prior use to the vehicle buyer, wherein the vehicle buyer is allowed to proceed forward if the disclosures are acknowledged by the vehicle buyer, the acknowledgement by the vehicle buyer generating at least one acknowledgement code,
e) transmission from the one or more remote devices to a server, of the predetermined prompts responded to by the dealer, acknowledgements thereto by the buyer, and the at least one acknowledgement code of the vehicle buyer, indicating disclosures by the vehicle dealer and acknowledgements by the vehicle buyer.

21. The non-transitory computer-readable medium of claim 20, the non-transitory computer-readable medium receives an activation code from the vehicle dealer to access third-party vehicle history providers unique to the vehicle identified by a VIN.
